(19) United States
(12) Patent Application Publication
(10) Pub. No.: US 2007/0156589 A1
(43) Pub. Date: Jul. 5, 2007

(54) Integrating personalized listings of media content into an electronic program guide

(76) Inventors: Randy Zimler, Gainesville, GA (US); Robert Koch, Norcross, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/322,708

(22) Filed: Dec. 30, 2005

(51) Int. Cl. G06Q 99/00

(52) U.S. Cl. 705/51

(57) ABSTRACT

Methods, computer programs, and systems for integrating personalized listings of media content into an electronic program guide. A user profile is retrieved that sets forth information about a user's preferences. Media content information is received that is indicative of a media type, a title, and/or descriptive information, for each of a plurality of available media selections. A media content recommendation is generated for the user by applying the user profile to the media content information, the recommendation setting forth at least one recommended media selection. The at least one recommended media selection is presented for display within the electronic program guide.

### BACKGROUND

The present invention relates generally to electronic program guides, and more particularly, to improved methods and computer programs for integrating personalized program listings into an electronic program guide.

Electronic program guides are utilized in conjunction with media delivery systems such as cable television, satellite television, and subscription-based interactive television. These guides store information indicative of the scheduled times at which each of a plurality of programs will be offered on each of a plurality of channels. When displayed on a media presentation device such as a television, the electronic program guide presents users with a menu of available programs from which to choose. By way of illustration, many cable systems provide all subscribers in a particular geographically defined television market with an electronic program guide that includes programs from a specified set of local network affiliates, as well as programs from a plurality of nationwide cable channels.

Subscription-based interactive television systems, such as TiVo, ReplayTV, EchoStar, and UltimateTV, use electronic program guides in conjunction with programs that may be viewed in the future, as well as programs that have already been recorded for subsequent viewing. These systems include program receiving devices equipped with memory for storing a subscriber's favorite television show, and a recording mechanism for automatically making a digital recording of the program each time it airs. In the case of TiVo, software is sent to the program receiving device for providing the subscriber with special interactive features, including the ability to manipulate recorded programs by pausing, rewinding or instantly replaying a portion of the broadcast, without missing succeeding action. UltimateTV includes a video processing mechanism by which users are able to receive Internet-based content. ReplayTV provides personal video recorders that allow users to search for programs based on keywords, such as an actor's name or the name of a movie.

Existing electronic program guides have significant shortcomings. Due to the large number of content providers, a user must oftentimes search through numerous program listings to locate a desired program. For example, electronic program guides may list all over-the-air broadcast networks such as ABC, CBS, NBC, PBS, Fox, UPN, WB, Univision, and Telemundo, as well as a multiplicity of cable outlets including the Discovery Channel, Nickelodeon, ESPN, CNN, HBO, Showtime, Movie Channel, and others. Users may fail to spot a desired program listing, or may disregard an unfamiliar program listing that, nonetheless, would be of interest to the subscriber. What is needed is an improved electronic program guide from which a user is able to readily and expeditiously select one or more programs of interest.

### BRIEF SUMMARY

Exemplary embodiments include methods for integrating personalized listings of media content into an electronic program guide. The methods comprise retrieving a user profile setting forth information about a user's preferences. Media content information is received that is indicative of at least one of a media type, a title, or descriptive information, for each of a plurality of available media selections. A media content recommendation is generated for the user by applying the user profile to the media content information, the recommendation setting forth at least one recommended media selection. The at least one recommended media selection is presented for display within the electronic program guide.

These methods can also be viewed as providing computer program products for integrating personalized listings of media content into an electronic program guide. The computer program products include a storage medium readable by a processing circuit and storing instructions for execution by the processing circuit for facilitating a method. The facilitated method includes retrieving a user profile setting forth information about a user's preferences. Media content information is received which is indicative of at least one of a media type, a title, or descriptive information, for each of a plurality of available media selections. A media content recommendation is generated for the user by applying the user profile to the media content information, the recommendation setting forth at least one recommended media selection. The at least one recommended media selection is presented for display within the electronic program guide.

Other exemplary embodiments include systems for integrating personalized listings of media content into an electronic program guide. These systems comprise a computer-readable storage medium for storing a user profile setting forth information about a user's preferences; a communications mechanism for receiving media content information indicative of at least one of: (i) a media type, (ii) a title, or (iii) descriptive information, for each of a plurality of available media selections; a processing mechanism, coupled to the communications mechanism and the computer-readable storage medium, for generating a media content recommendation for the user by applying the stored user profile to the received media content information, the recommendation setting forth at least one recommended media selection; and a display mechanism, in communication with the processing mechanism, for displaying the at least one recommended media selection within the electronic program guide.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is a block diagram showing systems for integrating personalized listings of media content into an electronic program guide according to various illustrative embodiments;

FIG. 2 is a flowchart setting forth methods for integrating personalized listings of media content into an electronic program guide according to various illustrative embodiments;

FIGS. 3A and 3B together comprise a flowchart setting forth methods for integrating personalized listings of media content into an electronic program guide according to a set of further embodiments disclosed herein; and

FIG. 4 is a diagrammatic representation of an illustrative personalized electronic program guide generated according to the methods disclosed herein.

The detailed description explains exemplary embodiments of the invention, together with advantages and features, by way of example with reference to the drawings.

### DETAILED DESCRIPTION OF EXEMPLARY EMBODIMENTS

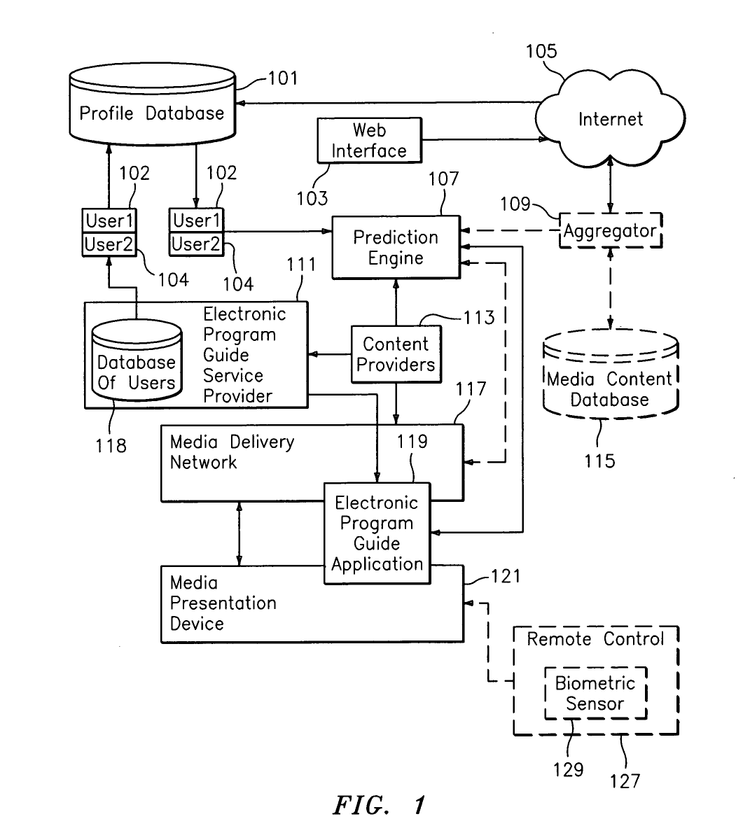

FIG. 1 is a block diagram showing systems for integrating personalized listings of media content into an electronic program guide according to various illustrative embodiments. Content providers 113 represent any source of media content, such as over-the-air television stations, cable channels, radio stations, Internet web sites, satellite broadcasts, electronic files stored on computer-readable storage devices, and others. For example, content providers 113 may include television networks such as ABC, CBS, NBC, WB, UPN, and FOX, individual television broadcasting stations such as WGN, cable channels such as the Discovery Channel, HBO and Showtime, any of a multiplicity of Internet web sites offering streaming media such as www.homeviewtnt.com, and any of a multiplicity of Internet web sites offering video or audio programs on demand.

Content providers 113 are capable of providing media content information describing available media content to an electronic program guide service provider 111. Illustratively, media content information is provided in the form of one or more keywords or other preference information, such as titles for each of a plurality of available media selections. Media content information may also include an identifier setting forth a media type, such as a movie, concert, TV show, radio broadcast, live performance (i.e., play, opera), sporting event, or interactive game. If the media type is a movie, then the media content information may identify one or more actors participating in a movie, as well as a movie genre (horror, science fiction, etc). If the media type is a concert, then the media content information may include a musical genre (jazz, classical, heavy metal, etc.). If the media selection type is a sporting event, then the media content information may identify two or more teams participating in the event, as well as a sporting event category (football, baseball, etc.). For a media selection that occurs at a prescheduled time, the media content information may identify a date and a time of day at which the media selection is scheduled to occur.

Electronic program guide service provider 111 includes a database of users 118 stored on a computer-readable storage medium such as a disk drive, magnetic storage medium, semiconductor memory, optical storage medium, or the like. Illustratively, database of users 118 is stored in the form of a list of media delivery network users who are authorized to access media content on content providers 113, such as a first user (user1) 102 and a second user (user2) 104. However, database of users 118 does not include information indicative of media preferences for the media delivery network users listed therein.

For one or more users identified in database of users 118, a user-specific user profile is stored in profile database 101. In the present example, profile database 101 stores user profiles for user1 102 and user2 104. User1 102 may represent an individual user, whereas user2 104 may represent a household comprised of a plurality of individuals. Profile database 101 is illustratively implemented using a computer server and a computer-readable data storage medium such as a disk drive, semiconductor memory, magnetic storage medium, optical storage medium, or the like.

The user profiles stored in profile database 101 include any information that is indicative of a user's preference for media content, such as keywords or other preference information relating to a preferred subject matter for media content, keywords or other preference information describing preferred genres of media content, keywords or other preference information describing preferred media types, identities of one or more frequently accessed content providers, and/or names of preferred actors, musicians, artists, performers, directors, or athletes who create media content. Illustrative subject matter keywords include, but are not limited, to “cooking”, “football”, “antiques”, and “fishing”. Examples of preferred genre keywords include, but are not limited, to “science fiction”, “action/adventure”, and “horror”. Media types include categories such as film, podcasts, music videos, television, radio, and others.

User profiles in profile database 101 are derived using information received from a user, information concerning past viewing habits of the user, known demographic information regarding the user, user information obtained from third party sources, information obtained upon the user subscribing to the media delivery network, or various combinations thereof. User profile keywords or other preference information could, but need not, be automatically generated for a user by monitoring media selections made by the user over a period of time. For example, if a user views a substantial number of Star Trek episodes, the keyword “science fiction” would be placed into this user's profile. Similarly, if the user views a number of programs carried by the NBC television network, the keyword “NBC” would be placed into this user's profile.

The user profile may, but need not, be created by means of a user entering information into a web interface 103 which then conveys the entered information over the Internet 105 to profile database 101. Profile database 101 may, but need not, be stored locally in a media presentation device 121. Media presentation device 121 represents any device capable of generating audible, visual, or audiovisual output from an electronic signal received from a media delivery network 117. Illustratively, media presentation device 121 is implemented using an analog television set in combination with a set-top box, a television set capable of demodulating and processing signals in digital form, a computing device that includes an electronic display or an audio output port or both, or a radio receiving device capable of demodulating and processing signals in digital form. If profile database 101 is stored in media presentation device 121, then updates to the profile database can be performed locally by the user without the necessity of traversing media delivery network 117. Illustratively, media presentation device 121 could be programmed to display one or more menu screens by which profile database 101 may be edited or updated.

Web interface 103 may be implemented using a personal computer, laptop computer, or other computing device that is capable of communicating over the Internet 105. The entered information could include one or more keywords, or other preference information indicative of a user preference. Optionally, web interface 103 may be capable of implementing a dialogue with a user so as to elicit information for entry into the user profile.

Optionally, the user profile may be derived from information received from the user in the context of a service provider-customer relationship. For example, a user wishing to subscribe to media delivery network 117 may be required to submit a credit card number, street address, telephone number, and other billing information to a service provider. This information is indicative of the economic status of the user, and could be placed into the user profile.

A prediction engine 107 receives a user profile, such as a profile for user1 102, from profile database 101. Prediction engine 107 may be implemented by a computing device such as a computer server, a group of computer servers, a mainframe computer, a personal computer or a laptop computer. In addition to user profiles, prediction engine 107 receives media content information from content providers 113. Based upon the information contained within a user profile, such as a profile for user1 102, and media content information received from content providers 113, prediction engine 107 generates at least one media content recommendation for user1 102.

The media content recommendation sets forth a recommended media selection available from content providers 113. Searching through media content information received from content providers 113, the media content recommendation is generated by identifying one or more selections that most closely provide a match for the user profile when substantially all media selections included in the media content information are considered. Illustratively, the media content recommendation is generated by identifying media content information that is substantially identical, similar, or related to any of the keywords or other preference information in the user profile.

Electronic program guide service provider 111 provides an electronic template for a media content guide. The template is received by an electronic program guide application 119. The at least one recommended media selection generated by prediction engine 107 is also received by electronic program guide application 119. Electronic program guide application 119 is programmed to place the at least one recommended media selection into the electronic template to generate a completed template. Optionally, additional media content information from content providers 113 is placed into the completed template. Using the completed template, electronic program guide application 119 is programmed to generate an electronically displayable media content guide for display on a media presentation device 121. Since the media content guide incorporates at least one selection generated by prediction engine 107, the guide is thereby customized for a specific user, such as user1 102.

Electronic program guide application 119 may reside at media presentation device 121, media delivery network 117, or both. Media delivery network 117 represents any network component, connectable to media presentation device 121, which is capable of electronically conveying media content from content providers 113 to media presentation device 121. By way of example, media delivery network 117 comprises a cable system head end, a residential gateway, a media server, or an over-the-air antenna that receives broadcasts from content providers in the form of terrestrial and/or satellite television stations.

Preferably, electronic program guide application 119 is programmed to place the at least one recommended media selection at or near the top of the media content guide as the guide is displayed on a media presentation device 121. In addition or in lieu of placing the at least one recommended media selection at or near the top, the at least one recommended media selection may be placed within a prominent or highlighted region of the media content guide as the guide is displayed on media presentation device 121.

Electronic program guide application 119 may, but need not, be programmed to generate a media content guide organized chronologically in a graphical or tabular format, so as to provide a menu of programs, movies, concerts, performances, or events that are to occur at each of a plurality of prescheduled times. However, the available media content may also include programs, movies, concerts, performances, or events that may be played back on demand at any time. Items that are available on demand could, but need not, be listed in a separate portion of the media content guide that is not chronologically organized.

Pursuant to a set of further embodiments disclosed herein, an optional aggregator 109 searches the Internet 105 for media content. Upon locating an item of media content on the Internet 105, aggregator 109 stores information identifying the media content in an optional media content database 115. In addition to storing information identifying the media content, media content database 115 is also capable of storing a uniform resource locator (URL) comprising an Internet address for the item of media content. Items of media content may include electronic files stored on computer-readable storage devices, as well as Internet web sites offering streaming video, streaming audio, or other types of media content. Accordingly, when prediction engine 107 is generating a media content recommendation as described above, the prediction engine may perform a search of media content located by aggregator 109 and stored in media content database 115, in lieu of, or in addition to, performing a search of media content information received from content providers 113.

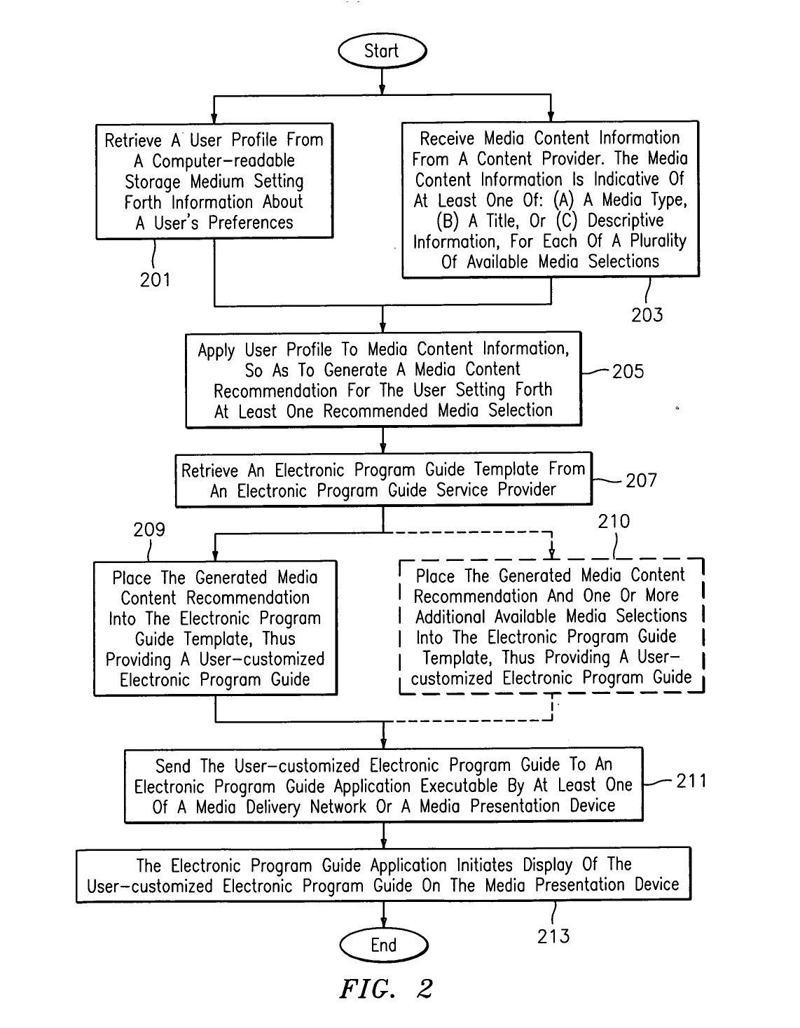

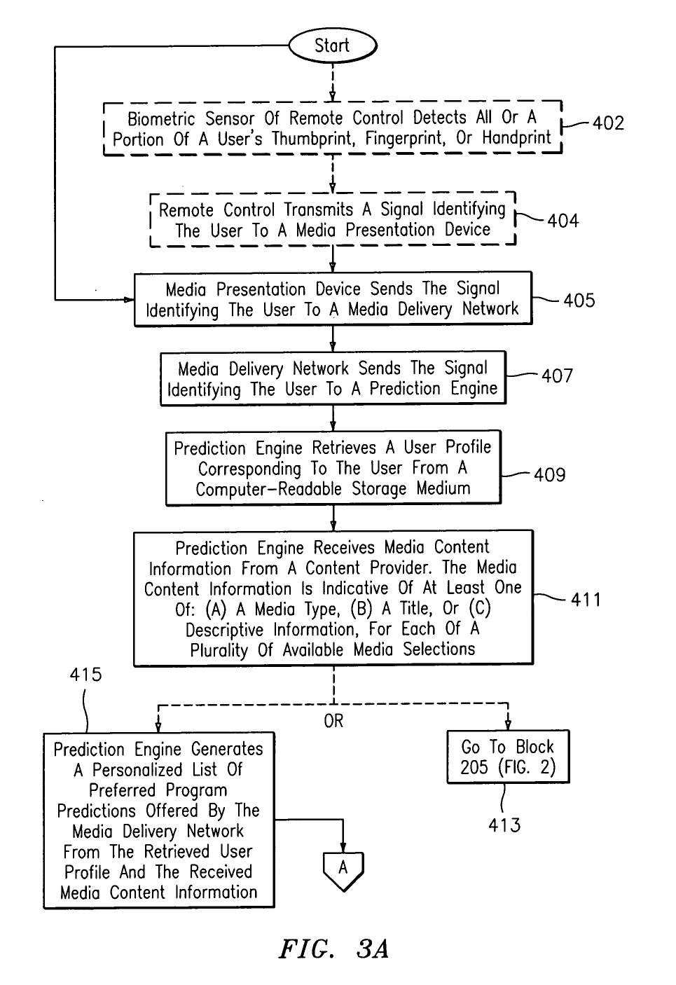

FIG. 2 is a flowchart setting forth methods for integrating personalized listings of media content into an electronic program guide according to various illustrative embodiments. These methods could, but need not, be performed using only a set-top box associated with media presentation device 121 (FIG. 1), or illustratively performed only using elements contained within the media presentation device. The operations of block 201 (FIG. 2) may be performed before, after, or contemporaneously with the operations of block 203. At block 201, a user profile is retrieved which sets forth information about a user. The user profile is retrieved from a computer-readable storage medium such as profile database 101 (FIG. 1). Optionally, the user profile may be stored in an encrypted form to provide an enhanced measure of privacy. At block 203 (FIG. 2), media content information is received from a content provider such as content providers 113 (FIG. 1). This media content information is indicative of at least one of (a) a media type, (b) a title, or (c) descriptive information, for each of a plurality of available media selections.

“Media type” is used to categorize each of a plurality of available media selections into one of several media categories, such as movie, concert, TV show, radio broadcast, live performance, sporting event, or interactive game. In the case of a sporting event, “title” may specify the names of the teams participating in the event. The title of a concert may include the names of one or more performers or groups participating in the concert. The titles of TV shows, radio broadcasts, live performances, and movies are self-explanatory. “Descriptive information” is used to provide one or more keywords or other preference information related to the subject matter or genre of available media selections. If a media selection is a movie, “descriptive information” may indicate a science fiction movie from the Star Trek series.

Next, the user profile is applied to media content information, so as to generate a media content recommendation for the user (FIG. 2, block 205). Optionally, the user profile may store information about programs that the user never wishes to view, such as football games, with the effect that such programs will not be included in the media content recommendation. In any case, the media content recommendation sets forth at least one recommended media selection. At block 207, an electronic program guide template is retrieved from electronic program guide service provider 111 (FIG. 1). The generated media content recommendation is placed into the electronic program guide template, thus providing a user-customized electronic program guide (FIG. 2, block 209). Optionally, block 210 may be performed, in which case one or more additional media selections are placed into the electronic program guide template, in addition to the media content recommendation that was generated at block 205. These additional media selections need not be user-specific recommendations, but instead may represent a list of all channels available from media delivery network 117 (FIG. 1).

At block 211 (FIG. 2), the user-customized electronic program guide is sent to an electronic program guide application executable by at least one of media delivery network 117 (FIG. 1) or media presentation device (121). Next, at block 213 (FIG. 2), the user-customized electronic program guide application 119 (FIG. 1) initiates a display of the user-customized electronic program guide on media presentation device 121.

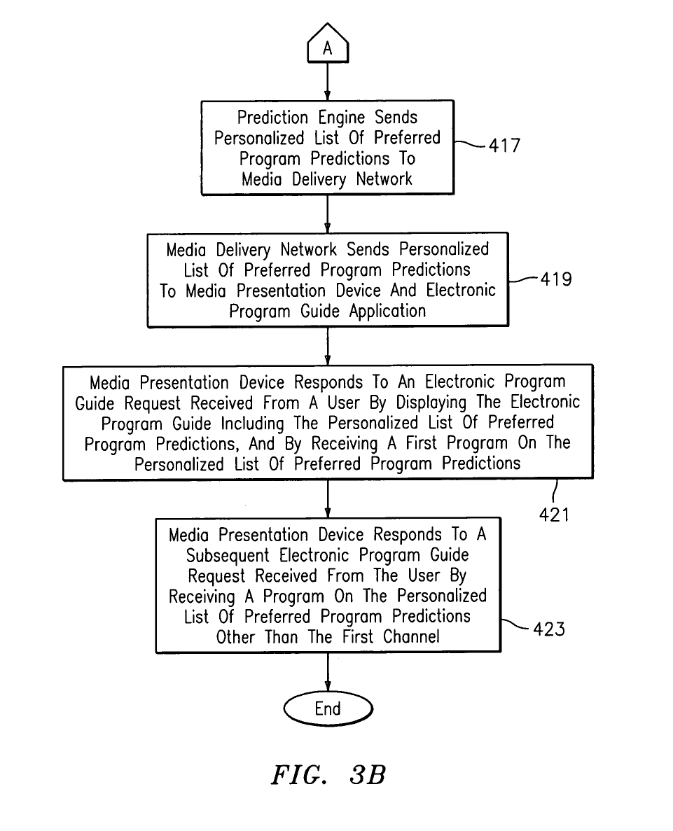

FIGS. 3A and 3B together comprise a flowchart setting forth methods for integrating personalized listings of media content into an electronic program guide according to a set of further embodiments disclosed herein. Pursuant to this set of further embodiments, media presentation device 121 (FIG. 1) is capable of being controlled by an optional remote control 127 equipped with an optional biometric sensor 129. The procedure of FIGS. 3A and 3B commences at block 405 or, optionally, the operations of blocks 402 and 404 are performed prior to block 405. At block 402, the biometric sensor detects all or a portion of a user's thumbprint, fingerprint, or handprint. Next (FIG. 3A, block 404), the remote control transmits a signal identifying the user to the media presentation device. The program then progresses to block 405.

At block 405, representing commencement of the procedure of FIGS. 3A and 3B if optional blocks 402 and 404 are not performed, the media presentation device transmits the signal identifying the user to media delivery network 117 (FIG. 1). The user may also be identified by a unique identifier that is pre-stored on the media presentation device. Then, at block 407 (FIG. 3A), the media delivery network sends the signal identifying the user to prediction engine 107 (FIG. 1). At block 409, the prediction engine retrieves a user profile corresponding to the user from a computer-readable storage medium such as profile database 101 (FIG. 1). Referring to block 411 (FIG. 3), the prediction engine receives media content information from content providers 113 (FIG. 1). As described above in connection with FIG. 2, this media content information is indicative of at least one of: (a) a media type, (b) a title, or (c) descriptive information, for each of a plurality of available media selections.

Next, program control progresses either to block 415 (FIG. 3A), or to block 205 of FIG. 2, depending upon the design requirements of a particular system application. For example, if it is desired to provide users with a personalized list of preferred program predictions, the operational sequence of blocks 415-423 is performed; otherwise, program control progresses to block 205 (FIG. 2). If program control progresses to block 205 of FIG. 2, the resulting operational sequence initiates generation of at least one predicted media selection for the user which is placed into an electronic program guide in accordance with the procedures described above (FIG. 2, blocks 205-213).

If program control progresses to block 415 (FIG. 3A), the prediction engine generates a personalized list of preferred program predictions from program listings offered by the media delivery network. The personalized list is generated using the retrieved user profile and the received media content information. This list is displayed in a prominent position of an electronic program guide menu, illustratively by placing the list at or towards the top of the menu, and/or illustratively by displaying a visual indication (icon or highlighting) that tends to draw attention to the list. The program advances to block 417 (FIG. 3B), where the prediction engine sends the personalized list of preferred program predictions to the media delivery network. The media delivery network sends the personalized list of preferred program predictions to the media presentation device and the electronic program guide application (block 419). The media presentation device responds to entry of an electronic program guide request from the user by displaying the electronic program guide including the personalized list of preferred program predictions, and receiving a first program on the personalized list of preferred program predictions (block 421). The media presentation device responds to a subsequent electronic program guide request from the user by receiving a program on the personalized list of preferred program predictions other than the first program (block 423). The personalized list of preferred program predictions could, but need not, specify interactive games or other media content in addition to audiovisual programs. For example, the foregoing functionality could be utilized to invite the user to join an online game that is scheduled for a certain time.

Optionally, the operational sequence of blocks 415-423 is repeated for each of a plurality of media types, such as music, audiovisual programs, and games, to generate a personalized list of preferred program predictions for each of a plurality of different media types. These personalized lists are generated by the prediction engine from the user's profile as retrieved from the profile database, and the personalized lists are then transmitted via the media delivery network and the media presentation device to the remote control. The remote control is equipped with an optional “media type” button which, when activated, causes the media presentation device to initiate scanning through all programs on the personalized list of preferred program predictions for a first media type. Upon subsequent activation of the “media type” button, the media presentation device initiates scanning through all programs on the personalized list of preferred program predictions for a second media type.

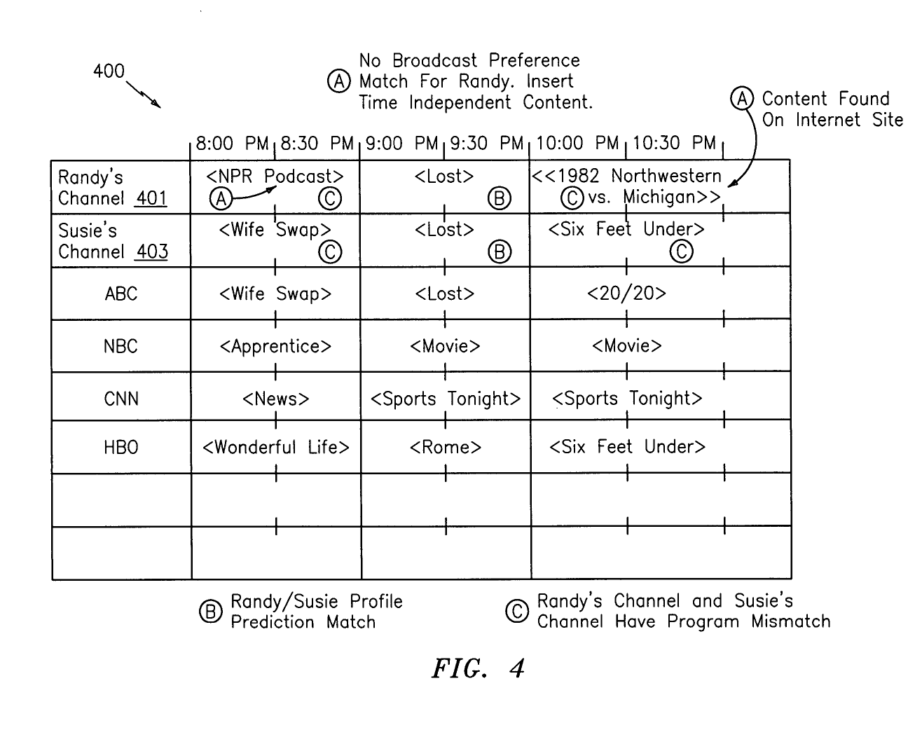

FIG. 4 is a diagrammatic representation of an illustrative personalized list of preferred program predictions 400 generated according to the methods disclosed herein. In the present example, personalized list of preferred program predictions 400 sets forth a first personalized list of preferred program predictions for a first user, denoted as Randy's Channel 401, and a second personalized list of preferred program predictions for a second user, denoted as Susie's Channel 403. Randy's Channel 401 represents a prediction of what, out of all the available media content included in the electronic program guide, is predicted to be the most likely program Randy would want to watch now, without having to scroll through a multiplicity of electronic program guide pages to find this program. Similarly, Susie's Channel 403 represents a prediction of what, out of all the available media content included in the electronic program guide, is predicted to be the most likely program Susie would want to watch now, without having to scroll through a multiplicity of electronic program guide pages to find this program. In addition to Randy's Channel 401 and Susie's Channel 403, personalized list of preferred program predictions 400 also includes a list of available media content from each of a plurality of media content providers, such as ABC, NBC, CNN, and HBO.

Some of the preferred program predictions in Randy's Channel 401 and Susie's Channel 403 may be broadcasts that occur at a prescheduled time, such as the Wife Swap program on ABC, whereas other preferred program predictions may be on-demand programs available for download from the Internet, such as a 1982 football game between Northwestern and Michigan. Illustratively, if no preferred program prediction in the form of a broadcast is predicted for a given user in a given time slot, then the preferred program prediction is generated by considering on-demand programs available from the Internet. For example, in the 10:00-11:00 PM timeslot, Randy's Channel 401 includes an on-demand football game because no broadcast program was predicted for Randy during this time. During some scheduled periods, such as the 9:00-10:00 timeslot, both Randy's Channel 401 and Susie's Channel 403 indicate the same preferred program prediction, such as “Lost” on ABC. However, during other time periods, including 8:00 PM to 9:00 PM, Randy's Channel 401 and Susie's Channel 403 indicate different program predictions. Randy is predicted to prefer an NPR podcast, whereas Susie is predicted to prefer “Wife Swap” on ABC.

As described above, exemplary embodiments can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for presenting recommended media selections in an electronic program guide, the method comprising:
retrieving a user profile setting forth information about a user's preferences;
receiving media content information indicative of at least one of: (i) a media type, (ii) a title, or (iii) descriptive information, for each of a plurality of available media selections;
generating a media content recommendation for the user by applying the user profile to the media content information, the recommendation setting forth at least one recommended media selection; and
presenting for display the at least one recommended media selection within the electronic program guide.

2. The method of claim 1 wherein the user profile is created using at least one of: information received from a user, information concerning past viewing habits of the user, demographic information regarding the user, user information obtained from third party sources, or information obtained upon the user subscribing to a media delivery network capable of delivering media content to the media presentation device.

3. The method of claim 1 wherein the media content recommendation is generated by searching the media content information to identify one or more media selections which most closely match the user profile when substantially all media selections in the media content information are considered.

4. The method of claim 1 wherein the media type classifies each of a plurality of available media selections into a category selected from a plurality of categories, and wherein the plurality of categories comprises at least two of: movies, concerts, television shows, radio broadcasts, live performances, sporting events, or interactive games.

5. The method of claim 1 wherein the user profile contains information indicative of the user's preference for media content, the information comprising at least one of: a keyword relating to a preferred subject matter for media content, a keyword describing a preferred genre of media content, a keyword identifying one or more frequently accessed media content providers, or a name identifying a preferred actor, musician, artist,

6. The method of claim 5 wherein the media content recommendation is generated by searching the media content information to identify one or more media selections which are most closely related to any keyword in the user profile when substantially all media selections in the media content information are considered.

7. The method of claim 1 wherein the user profile is created by the user entering information into a web interface coupled to the computer-readable storage medium through a network.

8. A system for integrating personalized program listings into an electronic program guide, the system comprising:
a computer-readable storage medium for storing a user profile setting forth information about a user's preferences;
a communications mechanism for receiving media content information indicative of at least one of: (i) a media type, (ii) a title, or (iii) descriptive information, for each of a plurality of available media selections;
a processing mechanism, coupled to the communications mechanism and the computer-readable storage medium, for generating a media content recommendation for the user by applying the stored user profile to the received media content information, the recommendation setting forth at least one recommended media selection; and
a display mechanism, in communication with the processing mechanism, for displaying the at least one recommended media selection within the electronic program guide.

9. The system of claim 8 wherein the user profile is created using at least one of: information received from a user, information concerning past viewing habits of the user, demographic information regarding the user, user information obtained from third party sources, or information obtained upon the user subscribing to a media delivery network capable of delivering media content to the media presentation device.

10. The system of claim 8 wherein the processing mechanism generates the media content recommendation by searching the media content information to identify one or more media selections which most closely match the user profile when substantially all media selections in the media content information are considered.

11. The system of claim 8 wherein the media type classifies each of a plurality of available media selections into a category selected from a plurality of categories, and wherein the plurality of categories comprises at least two of: movies, concerts, television shows, radio broadcasts, live performances, sporting events, or interactive games.

12. The system of claim 8 wherein the user profile contains information indicative of the user's preference for media content, the information comprising at least one of: a keyword relating to a preferred subject matter for media content, a keyword describing a preferred genre of media content, a keyword identifying one or more frequently accessed media content providers, or a name identifying a preferred actor, musician, artist, performer, director, or athlete.

13. The system of claim 12 wherein the media content recommendation is generated by searching the media content information to identify one or more media selections which are most closely related to any keyword in the user profile when substantially all media selections in the media content information are considered.

14. The system of claim 8 wherein the user profile is created by the user entering information into a web interface coupled to the computer-readable storage medium through a network.

15. A computer program product for integrating personalized listings of media content into an electronic program guide, the computer program product comprising:
a storage medium readable by a processing circuit and storing instructions for execution by the processing circuit for facilitating
a method comprising:
retrieving a user profile setting forth information about a user's preferences;
receiving media content information indicative of at least one of: (i) a media type, (ii) a title, or (iii) descriptive information, for each of a plurality of available media selections;
generating a media content recommendation for the user by applying the user profile to the media content information, the recommendation setting forth at least one recommended media selection; and
presenting for display the at least one recommended media selection within the electronic program guide.

16. The computer program product as recited in claim 15 further including instructions for creating the user profile using at least one of: information received from a user, information concerning past viewing habits of the user, demographic information regarding the user, user information obtained from third party sources, or information obtained upon the user subscribing to a media delivery network capable of delivering media content to the media presentation device.

17. The computer program product as recited in claim 15 further including instructions for generating the media content recommendation by searching the media content information to identify one or more media selections which most closely match the user profile when substantially all media selections in the media content information are considered.

18. The computer program product as recited in claim 15 wherein the media type classifies each of a plurality of available media selections into a category selected from a plurality of categories, and wherein the plurality of categories comprises at least two of: movies, concerts, television shows, radio broadcasts, live performances, sporting events, or interactive games.

19. The computer program product as recited in claim 15 wherein the user profile contains information indicative of the user's preference for media content, the information comprising at least one of: a keyword relating to a preferred subject matter for media content, a keyword describing a preferred genre of media content, a keyword identifying one or more frequently accessed media content providers, or a name identifying a preferred actor, musician, artist, performer, director, or athlete.

20. The computer program product of claim 15 further including instructions for generating the media content recommendation by searching the media content information to identify one or more media selections which are most closely related to any keyword in the user profile when substantially all media selections in the media content information are considered.
